(19) United States
(12) Patent Application Publication
(10) Pub. No.: US 2026/0187889 A1
(43) Pub. Date: Jul. 2, 2026

(54) TOPIC, TONE, PERSONA, AND VISUALLY-AWARE VIRTUAL-REALITY AND AUGMENTED-REALITY ASSISTANTS

(71) Applicant: Concentrix CVG Customer Management Delaware LLC, Cincinnati, OH (US)

(72) Inventors: Pethachi Pichappan, Tampa, FL (US); Ankit Pareek, Bengaluru (IN)

(21) Appl. No.: 19/129,346

(22) PCT Filed: Oct. 16, 2023
(86) PCT No.: PCT/US2023/035174

§ 371 Date: May 13, 2025

(30) Foreign Application Priority Data
Nov. 14, 2022 (IN) 202211065116

(51) Int. Cl. G06T 13/20; G06F 9/451; G06F 40/35; G06F 40/40; G06T 13/40

(52) U.S. Cl. CPC G06T 13/205; G06F 9/453; G06F 40/35; G06F 40/40; G06T 13/40; G06T 2200/24

(57) ABSTRACT

Systems and methods for virtual assistant systems can leverage one or more machine-learned models and one or more assistant rendering assets to provide immersive and informative assistance. The systems and methods can leverage the one or more machine-learned models for tone understanding and/or semantic understanding to provide an informed response to a user that can be tailored to the intent of the input data and the tone of the input. Additionally and/or alternatively, the output for the response can include an assistant rendering asset specialized for a particular expert area.

### RELATED APPLICATIONS

This application claims priority to and the benefit of Indian Provisional Patent Application No. 202211065116, filed Nov. 14, 2022. Indian Provisional Patent Application No. 202211065116 is hereby incorporated by reference in its entirety.

### FIELD

The present disclosure relates generally to virtual assistant systems. More particularly, the present disclosure relates to an immersive virtual assistant system for contact center services that leverage one or more machine-learned models and virtual-reality rendering assets.

### BACKGROUND

The internet provides access to a plurality of different knowledge databases, websites, and services. However, as the amount of information continues to grow and the complexity of the information increases, assistance may be needed. Call centers can be time consuming with long queues and may lead to a plurality of different redirects before the correct agent is reached. Additionally, certain times of day and/or certain types of services may have limited resources which can increase the hold time.

### SUMMARY

Aspects and advantages of embodiments of the present disclosure will be set forth in part in the following description, or can be learned from the description, or can be learned through practice of the embodiments.

One example aspect of the present disclosure is directed to a computing system. The system can include one or more processors and one or more non-transitory computer-readable media that collectively store instructions that, when executed by the one or more processors, cause the computing system to perform operations. The operations can include obtaining a service request from a user. The service request can be associated with one or more service types. In some implementations, each service type can be associated with a specific topic. The operations can include determining the one or more service types based at least in part on the service request and obtaining a topic-specific dataset and one or more machine-learned models based on the one or more service types. The topic-specific dataset can be associated with a particular topic that is associated with the one or more service types. The operations can include obtaining a particular virtual-reality rendering experience based at least in part on the one or more service types. The particular virtual-reality rendering experience can be obtained from a virtual-reality database including a plurality of virtual-reality rendering experiences. In some implementations, the particular virtual-reality rendering experience can include an assistant rendering asset associated with the one or more service types. The operations can include obtaining input data from the user. The input data can include dialogue data descriptive of one or more lines of dialogue. The operations can include determining, by processing the input data with the one or more machine-learned models and based on the topic-specific dataset, a particular response. The particular response can be responsive to the one or more lines of dialogue. The operations can include providing a virtual-reality output. In some implementations, the virtual-reality output can include a rendering of the assistant rendering asset simulating vocally-communicating the particular response.

Another example aspect of the present disclosure is directed to a computer-implemented method. The method can include obtaining, by a computing system including one or more processors, a topic-specific dataset. The topic-specific dataset can include a plurality of input examples and a plurality of output examples associated with one or more particular service types. The method can include training, by the computing system, one or more topic-specific machine-learned models based on the topic-specific dataset. In some implementations, the one or more topic-specific machine-learned models can include one or more natural language processing models. The method can include obtaining, by the computing system, asset-generation input data. The asset-generation input data can be associated with one or more attributes of a specific agent. The method can include generating, by the computing system, an assistant rendering asset based on the asset-generation input data and associating, by the computing system, the one or more topic-specific machine-learned models and the assistant rendering asset with the one or more particular service types. The method can include storing, by the computing system, the one or more topic-specific machine-learned models and the assistant rendering asset in a virtual service database. The virtual service database can include a plurality of searchable datasets.

Another example aspect of the present disclosure is directed to one or more non-transitory computer-readable media that collectively store instructions that, when executed by one or more computing devices, cause the one or more computing devices to perform operations. The operations can include obtaining a service request from a user. The service request can be associated with one or more service types. In some implementations, each service type can be associated with a specific topic. The operations can include determining the one or more service types based at least in part on the service request and obtaining a topic-specific dataset and one or more machine-learned models based on the one or more service types. The topic-specific dataset can be associated with a particular topic that is associated with the one or more service types. The operations can include obtaining input data from the user. In some implementations, the input data can include dialogue data descriptive of one or more lines of dialogue. The operations can include determining a particular tone of the one or more lines of dialogue based on processing the input data with one or more tone blocks. The operations can include determining, by processing the input data and the particular tone with the one or more machine-learned models and based on the topic-specific dataset, a particular response. The particular response can be responsive to the one or more lines of dialogue. The operations can include providing a virtual-reality output. The virtual-reality output can include a rendering of an assistant rendering asset simulating vocally-communicating the particular response.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example computing system that performs virtual-reality response generation according to example embodiments of the present disclosure.

FIG. 2 depicts a block diagram of an example virtual-reality assistant pipeline according to example embodiments of the present disclosure.

FIG. 3 depicts a block diagram of an example virtual-reality assistant pipeline according to example embodiments of the present disclosure.

FIG. 4 depicts a block diagram of an example machine-learned model according to example embodiments of the present disclosure.

FIG. 5 depicts a block diagram of an example assistant rendering asset generation according to example embodiments of the present disclosure.

FIG. 6 depicts a flow chart diagram of an example method to perform virtual-reality response generation according to example embodiments of the present disclosure.

FIG. 7 depicts a flow chart diagram of an example method to perform virtual assistant database generation according to example embodiments of the present disclosure.

FIG. 8 depicts a flow chart diagram of an example method to perform virtual-reality response generation according to example embodiments of the present disclosure.

Reference numerals that are repeated across plural figures are intended to identify the same features in various implementations.

### DETAILED DESCRIPTION

Generally, the present disclosure is directed to systems and methods for providing an immersive virtual assistant system for contact center services. In particular, the systems and methods disclosed herein can leverage one or more machine-learned models, virtual-reality rendering and/or augmented-reality rendering, and/or one or more user interface elements. The systems and methods may utilize natural language processing, speech to text, text to speech, computer vision, emotion determination, sentiment analysis, and/or knowledge management techniques. For example, the systems and methods can include obtaining a service request from a user. The service request can be associated with one or more service types. In some implementations, each service type can be associated with a specific topic. The systems and methods can include determining the one or more service types based at least in part on the service request. The systems and methods can include obtaining a topic-specific dataset and one or more machine-learned models based on the one or more service types. The topic-specific dataset can be associated with a particular topic that is associated with the one or more service types. The systems and methods can include obtaining a particular virtual-reality rendering experience based at least in part on the one or more service types. The particular virtual-reality rendering experience can be obtained from a virtual-reality database comprising a plurality of virtual-reality rendering experiences. In some implementations, the particular virtual-reality rendering experience can include an assistant rendering asset associated with the one or more service types. The systems and methods can include obtaining input data from the user. The input data can include dialogue data descriptive of one or more lines of dialogue. The systems and methods can include determining, by processing the input data with the one or more machine-learned models and based on the topic-specific dataset, a particular response. In some implementations, the particular response can be responsive to the one or more lines of dialogue. The systems and methods can include providing a virtual-reality output. The virtual-reality output can include a rendering of the assistant rendering asset simulating vocally-communicating the particular response.

The systems and methods can obtain a service request from a user. The service request can be associated with one or more service types (e.g., technical support, sales, accounting, payment services, etc.). In some implementations, each service type can be associated with a specific topic. The service request may be generated and/or obtained based on one or more interactions. The one or more interactions can include one or more interactions in a virtual environment (e.g., a virtual-reality environment, such as a virtual-reality store in which the interactions may be with a virtual reality store clerk). The service request may include a set of input data descriptive of one or more questions directed to a virtual entity (e.g., a virtual assistant rendering (e.g., a virtual avatar of an artificial intelligence chat bot)).

The systems and methods can determine the one or more service types based at least in part on the service request. The one or more service types can be associated with a customer service topic that includes specialized information. The one or more service types can be determined based on metadata associated with the service request, one or more keywords associated with the service request, the input data of the service request (e.g., one or more lines of dialogue spoken and/or input via text input), a location in a physical world, a location in a virtual environment, a currently visited web page, and/or one or more other contextual datasets.

A topic-specific dataset and one or more machine-learned models can be obtained based on the one or more service types. The topic-specific dataset can be associated with a particular topic that is associated with the one or more service types. In some implementations, the one or more machine-learned models can include a natural language processing model. The natural language processing model may have been trained to determine a semantic intent of natural language data and generate a natural language output responsive to the natural language data. Additionally and/or alternatively, the one or more machine-learned models can include an augmentation model. The augmentation model may have been trained to determine assistant rendering asset movement based on an input text string. In some implementations, the one or more machine-learned models can include a tone model. The tone model may have been trained to determine a particular tone associated with the input data. The particular tone can be utilized to determine the particular response. In some implementations, the one or more machine-learned models may have been trained on the topic-specific dataset. The topic-specific dataset can include a plurality of input examples and a plurality of output examples associated with the one or more service types.

A particular virtual-reality rendering experience can then be obtained based at least in part on the one or more service types. The particular virtual-reality rendering experience can be obtained from a virtual-reality database including a plurality of virtual-reality rendering experiences. In some implementations, the particular virtual-reality rendering experience can include an assistant rendering asset associated with the one or more service types. The assistant rendering asset can be utilized to render a digital human to provide contact center services to a user.

The systems and methods can obtain input data from the user. The input data can include dialogue data descriptive of one or more lines of dialogue. The input data can be provided as part of the service request and/or may be obtained following the processing of the service request. The input data can include audio data, text data, image data, video data, and/or latent encoding data. The input data may be processed to generate natural language data that can then be processed by the one or more machine-learned models.

The systems and methods can determine, by processing the input data with the one or more machine-learned models and based on the topic-specific dataset, a particular response. The particular response can be responsive to the one or more lines of dialogue. The determination can include determining a tone associated with the input data, determining a semantic intent of the input data (e.g., a question associated with the input data), determining prediction data (e.g., a prediction of an answer to a determined question and/or response associated with the input data), and generating the particular response that is descriptive of the prediction data and is conditioned based on the determined tone. For example, a neural tone may be utilized for wording the response when a negative tone is determined (e.g., when profanity is utilized). Alternatively and/or additionally, an upbeat tone may be utilized when an upbeat tone is determined.

A virtual-reality output can be provided. The virtual-reality output can include a rendering of the assistant rendering asset simulating vocally-communicating the particular response. In some implementations, the virtual-reality output can include one or more three-dimensional renderings, one or more images, and/or one or more additional resources. The virtual-reality output may include a virtual-reality experience associated with the particular response that may include one or more additional indicators.

In some implementations, the systems and methods can obtain additional input data. The additional input data can be descriptive of one or more additional inputs. The systems and methods can determine the additional input data is associated with a redirect request. The redirect request can be descriptive of a transition to a communication portal. The systems and methods can generate a service communication portal in a user interface. In some implementations, the service communication portal can be associated with a specific agent associated with the one or more service types. The assistant rendering asset can be configured to appear similar to the specific agent. Therefore, a user can transition from listening to and watching an avatar interact with them then be redirected to a specific agent that looks and/or sounds similar to and/or the same as the avatar. For example, one or more assistant rendering assets can be generated based on the appearance and/or sound of particular live agents associated with a specific problem type, a specific expertise area, and/or a specific geographic region. The assistant rendering assets that were generated based on the particular live agent may be associated with the particular live agent, such that when a live agent transfer occurs, the user may be transferred to that particular live agent.

Additionally and/or alternatively, the systems and methods can include intelligent transfer to live agents. The transfer can be based on semantic analysis of the service request and/or one or more user inputs (e.g., interactions with the digital agent rendered using the assistant rendering asset). Which live agent to transfer to and when can be determined based on a determined problem, a determined service type, a determined problem complexity, a determined time of “a call” between the digital agent and the user, a determined topic area, a determined location, and/or a determined tone of the inputs by the user. The determinations can be performed by utilizing one or more machine-learned models and/or can include deterministic routing systems.

In some implementations, determining the additional input data is associated with the redirect request can include processing the additional input data with the one or more machine-learned models to generate predicted additional response data. The predicted additional response data can include a predicted additional response and a confidence score. In some implementations, the confidence score can be descriptive of a predicted likelihood that the predicted additional response is responsive to the additional input data. Determining the additional input data is associated with the redirect request can include determining the confidence score is below a threshold value.

Alternatively and/or additionally, determining the additional input data is associated with the redirect request can include determining the additional input data is descriptive of a selection of a redirect interface element (e.g., a “contact a human agent” user interface element, which may include a telephone call option, an email option, a messaging, and/or a video call option).

The user may be connected with a live agent (e.g., a specific agent) based on a determined tone (e.g., determining a user has become agitated), based on a determined lack of responsiveness by the virtual assistant system (e.g., determining the user is continuing to ask the same and/or similar questions), and/or based on a direct user interface selection.

The virtual-reality experience and the one or more machine-learned models can be stored in a virtual service database. Generating the virtual service database can include leveraging machine-model learning techniques and virtual rendering asset generation. For example, the systems and methods can include obtaining a topic-specific dataset. The topic-specific dataset can include a plurality of input examples and a plurality of output examples associated with one or more particular service types. The systems and methods can include training one or more topic-specific machine-learned models based on the topic-specific dataset. The one or more topic-specific machine-learned models can include one or more natural language processing models. The systems and methods can include obtaining asset-generation input data. In some implementations, the asset-generation input data can be associated with one or more attributes of a specific agent. The systems and methods can include generating an assistant rendering asset based on the asset-generation input data and associating the one or more topic-specific machine-learned models and the assistant rendering asset with the one or more particular service types. The systems and methods can include storing the one or more topic-specific machine-learned models and the assistant rendering asset in a virtual service database. The virtual service database can include a plurality of searchable datasets.

For example, the systems and methods can obtain a topic-specific dataset. The topic-specific dataset can include a plurality of input examples and a plurality of output examples associated with one or more particular service types. In some implementations, the plurality of input examples can be associated with a plurality of frequently asked questions. Additionally and/or alternatively, the plurality of output examples can be associated with a plurality of respective answers to the plurality of frequently asked questions.

One or more topic-specific machine-learned models can then be trained based on the topic-specific dataset. The one or more topic-specific machine-learned models can include one or more natural language processing models. The one or more topic-specific machine-learned models may be trained to understand topic-specific vocabulary and/or terminology. Additionally and/or alternatively, the one or more topic-specific machine-learned models may be trained to diagnose and/or determine one or more issues based on received input data.

The systems and methods can obtain asset-generation input data. The asset-generation input data can be associated with one or more attributes of a specific agent. In some implementations, the one or more attributes can include one or more visual attributes associated with the specific agent. The one or more attributes can include one or more audio attributes associated with the specific agent.

An assistant rendering asset can then be generated based on the asset-generation input data. The assistant rendering asset can be descriptive of a three-dimensional avatar that may resemble the specific agent. The assistant rendering asset may be generated to include similar facial features, similar facial movements, similar body movements, and/or a similar voice. In some implementations, the assistant rendering asset can be generated based at least in part on image data. The image data can include a plurality of images of a face in different poses. In some implementations, the image data can include video data descriptive of one or more videos of a person making facial movements. Additionally and/or alternatively, the assistant rendering asset can be generated based at least in part on audio data. The audio data can be descriptive of one or more recordings of a human speaking. The image data and/or the audio data can be processed to generate an assistant rendering asset that replicates the visual attributes and/or the audio attributes of a particular person (e.g., a specific agent that may be an expert in a topic area and/or a specific service type that the assistant rendering asset may be utilized for by the virtual assistant system).

The one or more topic-specific machine-learned models and the assistant rendering asset can be associated with the one or more particular service types. The association can include generating a data packet that may be stored with a service type specific label.

The one or more topic-specific machine-learned models and the assistant rendering asset can then be stored in a virtual service database. The virtual service database can include a plurality of searchable datasets. In some implementations, the one or more topic-specific machine-learned models and the assistant rendering asset can be stored in the virtual service database with a service label associated with the one or more particular service types.

Alternatively and/or additionally, the systems and methods can augment a response and/or generate a different type of response based on a determined tone of an input. For example, the systems and methods can include obtaining a service request from a user. The service request can be associated with one or more service types. In some implementations, each service type can be associated with a specific topic. The systems and methods can include determining the one or more service types based at least in part on the service request. The systems and methods can include obtaining a topic-specific dataset and one or more machine-learned models based on the one or more service types. The topic-specific dataset can be associated with a particular topic that is associated with the one or more service types. The systems and methods can include obtaining input data from the user. The input data can include dialogue data descriptive of one or more lines of dialogue. The systems and methods can include determining a particular tone of the one or more lines of dialogue based on processing the input data with one or more tone blocks and determining, by processing the input data and the particular tone with the one or more machine-learned models and based on the topic-specific dataset, a particular response. In some implementations, the particular response can be responsive to the one or more lines of dialogue. The systems and methods can include providing a virtual-reality output. The virtual-reality output can include a rendering of an assistant rendering asset simulating vocally-communicating the particular response.

The systems and methods can obtain a service request from a user. The service request can be associated with one or more service types. In some implementations, each service type can be associated with a specific topic.

The systems and methods can determine the one or more service types based at least in part on the service request. The determination may be based on one or more interactions with a user interface.

A topic-specific dataset and one or more machine-learned models can be obtained based on the one or more service types. The topic-specific dataset can be associated with a particular topic that is associated with the one or more service types.

The systems and methods can obtain input data from the user. The input data can include dialogue data descriptive of one or more lines of dialogue. In some implementations, the one or more lines of dialogue can include one or more questions associated with a particular service request.

The systems and methods can determine a particular tone of the one or more lines of dialogue based on processing the input data with one or more tone blocks. The particular tone may be determined based on processing with one or more machine-learned models of the one or more tone blocks. In some implementations, the one or more machine-learned models can include one or more language models trained to parse text and determine a tone of input data based on the segments individually and/or as a whole. In some implementations, the particular tone may be determined based on the vocabulary used, the syntax used, past interaction data, structure, setting tone of a voice, use of capitalization in text, and/or one or more other contextual features. The particular tone may be determined based in part on the one or more service types. For example, an input associated with a sales chat bot and help desk chat bot may be associated with different indicators and/or thresholds for different tones.

The systems and methods can determine, by processing the input data and the particular tone with the one or more machine-learned models and based on the topic-specific dataset, a particular response. The particular response can be responsive to the one or more lines of dialogue. In some implementations, the particular response can differ based on the particular tone.

A virtual-reality output can then be provided. The virtual-reality output can include a rendering of an assistant rendering asset simulating vocally-communicating the particular response. The virtual-reality output can include a visual output (e.g., a three-dimensional avatar displaying one or more movements) and an audio output (e.g., speech data that recites one or more words associated with the particular response).

In some implementations, providing the virtual-reality output can include obtaining a particular virtual-reality rendering experience based at least in part on the one or more service types. The particular virtual-reality rendering experience can be obtained from a virtual-reality database including a plurality of virtual-reality rendering experiences. The particular virtual-reality rendering experience can include the assistant rendering asset. In some implementations, the assistant rendering asset can be associated with the one or more service types.

In some implementations, the output may be an augmented-reality output and/or a mixed reality output. Alternatively and/or additionally, the output may include the assistant rendering asset rendered in a superimposed position over a current display (e.g., a web page and/or a viewfinder).

Additionally and/or alternatively, tone may reference a determined emotion based on audibly determined characteristics and/or textual characteristics (e.g., syntax and/or diction).

The systems and methods may include continuous processing of user input data to continue to adjust one or more determinations. The one or more determinations can include tone of the user, topic associated with the inputs, responsiveness of the responses, outputs for the digital agent rendered based on the assistant rendering asset, complexity of the problem, and time of the interaction.

For example, the systems and methods can include obtaining first input data. The first input data can be associated with one or more problems and/or one or more comments. The first input data can be utilized to determine to provide a digital agent (or digital assistant) to provide to the user that provided the first input data. The digital agent can be a rendered human avatar rendered based at least in part on an assistant rendering asset. The systems and methods can provide the digital agent for display via an augmented-reality experience, a virtual-reality experience, a mixed-reality experience, and/or via one or more other user interface elements.

One or more first responses can be determined for the first input data. The systems and methods can then provide the one or more first responses by generating first audio data that recites the one or more first responses. The first audio data can be generated based on a voice block (and/or voice model) that is conditioned on and/or trained on one or more example audio datasets associated with one or more individuals. The voice block can be part of the assistant rendering asset and/or can be part of a different dataset obtained based on one or more determinations (e.g., user tone, user-specific data, type of problem, etc.). Additionally and/or alternatively, one or more first digital agent movements (e.g., facial movements) can be determined based on the one or more first responses. The determination can be based on one or more learned movement models associated with one or more example datasets (e.g., one or more example datasets associated with the movements of one or more individuals). The one or more first responses, the first audio data, and the one or more first digital agent movements can be utilized to generate a first rendering of the digital agent providing the information of the one or more first responses to the user via an audio-visual presentation.

The systems and methods may then obtain second input data from the user, which can be responsive to the one or more first responses. The second input data can be processed to determine one or more second responses. In some implementations, a second assistant rendering asset may be obtained based on a determined tone change, a determined topic change, and/or one or more other determinations. Alternatively and/or additionally, the same assistant rendering asset may be utilized. Second audio data and/or one or more second digital agent movements can be determined based on the one or more second responses. The one or more second responses, the second audio data, and the one or more second digital agent movements can be utilized to generate a second rendering of the digital agent providing the information of the one or more second responses to the user via another audio-visual presentation.

The response determination and audio-visual presentation can be iteratively performed as further inputs are received. In some implementations, the systems and methods can determine when and/or whether to transfer the user from interacting with a digital agent to communicating with a live agent. Additionally and/or alternatively, the systems and methods can include to determining which live agent of a plurality of different live agents to connect the user with based on the user's inputs. For example, the systems and methods can obtain additional input data from the user. The additional input data can be processed to determine to transfer the user to a live agent. Additionally and/or alternatively, the first input data, the second input data, user-specific data (e.g., past interactions, user preferences, location data, user profile data, etc.), agent availability data, and/or the additional input data may be processed to determine a particular live agent to transfer the user to during transfer.

The determination of when and/or whether to transfer the user to a live agent can be based on a tone of the user (e.g., a general tone of the user (e.g., the tone determined based on audio processing, textual processing, and/or aggregate semantic processing) and/or a tone change), the determination of repeat questions, the determination of a lack of responsiveness by the one or more responses, a call time, a complexity of the problems provided by the user, and/or live agent availability. The determination of which live agent to transfer the user to during transfer can be based on a determined tone of the user (e.g., a particular live agent may be able to handle agitated users more readily based on past experiences and/or qualifications), a determined technical field of the problem provided by the user (e.g., a particular live agent may be associated with the technical field as a subject matter expert), a location of the user (e.g., a particular live expert may be in the same region as the user), and/or a determined availability (e.g., one or more particular live agents may be more readily available at the instance of user interaction). Each of the determinations can be iteratively updated as time elapses and more inputs are received. In some implementations, the digital agent provided can be determined based on an initial determination of tone and/or a determined technical field of the problem. The systems and methods can then determine after one or more interactions to transfer the user to a live agent. The systems and methods may determine to transfer the user to the live agent the digital agent was generated based on (e.g., one or more assistant rendering assets may be generated to render digital agents that mimic the appearance (and/or sound) of live agents, and the particular assistant rendering assets can be indexed as being associated with the particular live agents, which can allow the systems and methods to transfer users from digital agents that appear and sound like a particular live agent to that particular live agent).

The systems and methods disclosed herein can be utilized for contact centers, educational institutions, and/or a variety of other applications. Agents, assistants, and/or advisors may refer to an entity that provides suggestions and/or predictions and may be utilized in the same and/or similar implementations.

The systems and methods of the present disclosure provide a number of technical effects and benefits. As one example, the system and methods can provide a virtual assistant system for contact center services. For example, the systems and methods disclosed herein can provide an automated system for handling issues of a large number of users instantaneously without human caused queues.

Another technical benefit of the systems and methods of the present disclosure is the ability to leverage one or more machine-learned models to understand the input data and output a response tailored based on a determined tone. For example, the systems and methods can utilize one or more machine-learned models to determine a tone of an input and condition the generation of the response based on the determined tone.

Another example of technical effect and benefit relates to improved computational efficiency and improvements in the functioning of a computing system. For example, the systems and methods disclosed herein can leverage the specifically trained machine-learned models to provide accurate and tailored responses without querying an entire database for every single question.

With reference now to the Figures, example embodiments of the present disclosure will be discussed in further detail.

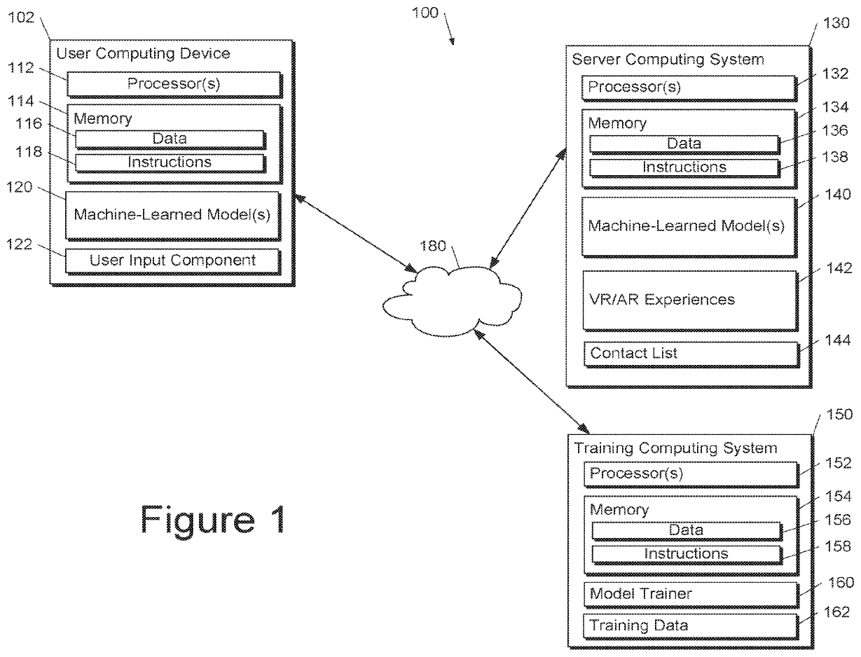

FIG. 1 depicts a block diagram of an example computing system 100 that performs virtual-reality response generation according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

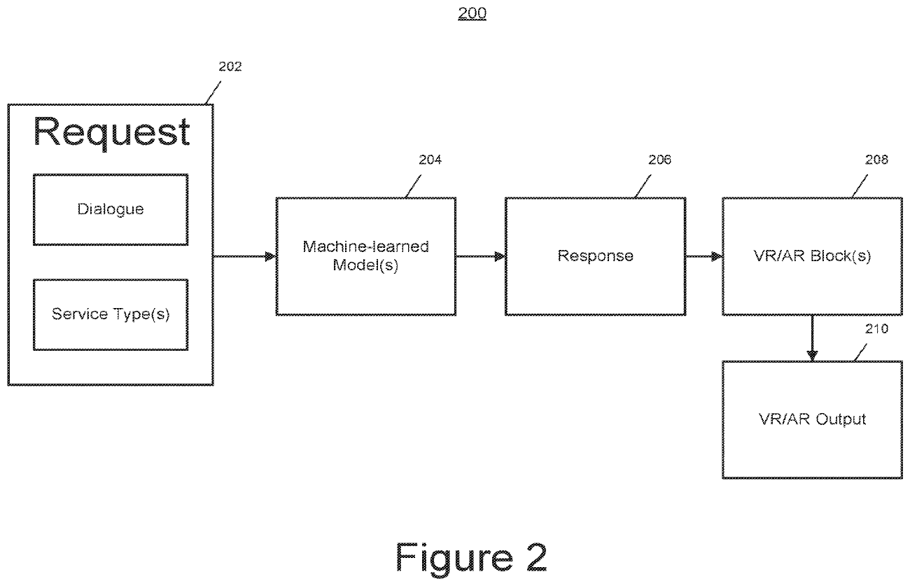

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example machine-learned models 120 are discussed with reference to FIGS. 2-4.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel virtual-reality response generation across multiple instances of user prompting).

More particularly, the one or more machine-learned models 120 can include one or more natural language processing models, one or more optical character recognition models, one or more segmentation models, one or more augmentation models, one or more classification models, one or more audio processing models, one or more tone models, and/or one or more virtual-reality models.

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., a chat bot service). Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIGS. 2-4.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

Additionally and/or alternatively, the server computing system 130 and/or the user computing device 102 can include one or more stored VR/AR experiences 142. The VR/AR experiences 142 can include one or more applications and/or datasets associated with rendering one or more rendering assets to provide a rendering user interface element.

Additionally and/or alternatively, the server computing system 130 and/or the user computing device 102 can include a stored contact list 144. The stored contact list 144 can be associated with one or more services associated with one or more chat bot services. The stored contact list 144 can be associated with one or more contact centers and may be utilized to redirect a user computing device 102 to a communication interface for communicating with one or more specific agents.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, natural language datasets, audio datasets, labeled datasets, ground truth datasets, topic-specific datasets, augmented-reality rendering datasets, and/or virtual-reality rendering datasets.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data (e.g., image data, audio data, location data, and/or other sensor data). The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1 illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

In some implementations, the systems and methods can include an example computing device that performs according to example embodiments of the present disclosure. The computing device can be a user computing device or a server computing device.

The computing device can include a number of applications (e.g., web browser applications, image capture applications, virtual-reality applications, augmented-reality applications, map-based applications, etc.). Each application can include a respective machine learning library and machine-learned model(s). For example, each application can include a machine-learned model. Example applications can include a chat bot application, a customer service application, an ecommerce application, a virtual-reality assistant application, a browser application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

In some implementations, the example computing device 50 that can perform according to example embodiments of the present disclosure can be a user computing device or a server computing device.

The computing device can include a number of applications (e.g., applications 1 through N). Each application can be in communication with a central intelligence layer. Example applications can include a chat bot application, a customer service application, an ecommerce application, a virtual-reality assistant application, a browser application, etc. In some implementations, each application can communicate with the central intelligence layer (and model(s) stored therein) using an API (e.g., a common API across all applications).

The central intelligence layer includes a number of machine-learned models. For example, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device.

The central intelligence layer can communicate with a central device data layer. The central device data layer can be a centralized repository of data for the computing device. In some implementations, the central device data layer can communicate with a number of other components of the computing device, such as, for example, one or more sensors, a context manager, a device state component, and/or additional components. In some implementations, the central device data layer can communicate with each device component using an API (e.g., a private API).

FIG. 2 depicts a block diagram of an example virtual-reality assistant pipeline 200 according to example embodiments of the present disclosure. In particular, the systems and methods can obtain a request 202 (e.g., a service request). The request 202 can include dialogue data (e.g., data descriptive of one or more lines of dialogue). The dialogue data can be natural language text data generated via speech to text processing and/or via one or more inputs to a keyboard (e.g., a physical keyboard and/or a graphical keyboard). In some implementations, the dialogue data can be selected from a plurality of options. Additionally and/or alternatively, the request 202 can include data descriptive of one or more service types. In some implementations, the dialogue data can be descriptive of the one or more service types.

The request 202 can be processed with one or more machine-learned models 204 to generate a response 206 responsive to the dialogue data as conditioned by the determined one or more service types. The response 206 can then be processed with one or more VR/AR blocks 208 to generate a VR/AR output 210. The VR/AR output 210 can include one or more virtual-reality and/or augmented-reality rendering assets that when rendering can depict an assistant rendering asset (e.g., an avatar) providing the particular response audibly and/or visually.

The pipeline can be iteratively repeated as additional inputs are obtained.

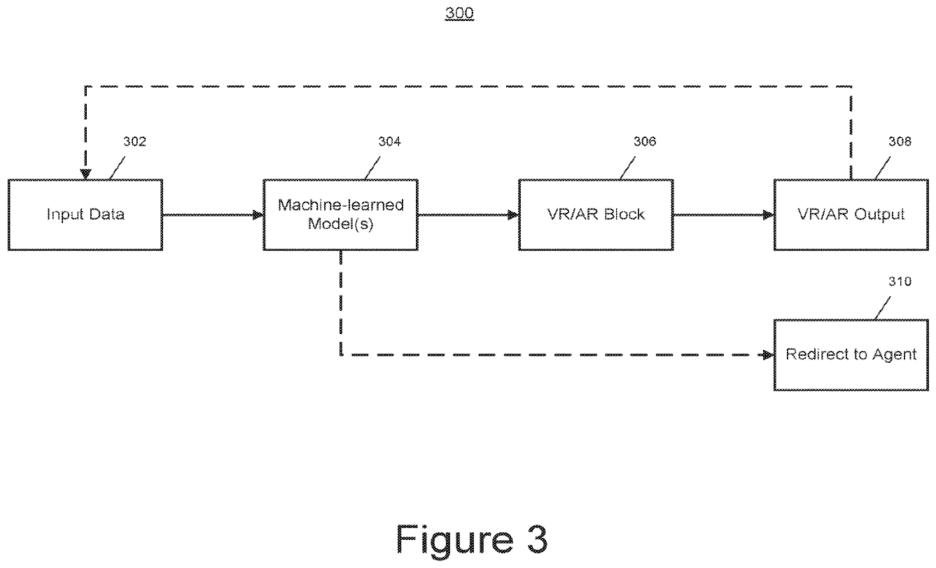

FIG. 3 depicts a block diagram of an example virtual-reality assistant pipeline 300 according to example embodiments of the present disclosure. In particular, the systems and methods can include obtaining input data 302. The input data 302 can be descriptive of one or more questions and/or one or more prompts. The input data 302 can be processed with one or more machine-learned models 304 to generate prediction data and one or more confidence scores associated with the prediction data. The one or more confidence scores can be associated with a likelihood that the prediction data is responsive to the input data 302 and/or a likelihood the prediction data is accurate. The prediction data can be generated by processing the input data 302 to generate a semantic understanding, determining a knowledge database associated with the semantic intent of the input data 302, querying the knowledge database to determine a predicted response, determining a tone of the input data 302, and generating the prediction data based on the predicted response and the determined tone.

If a confidence score is above a threshold, the prediction data can be processed with the VR/AR block 306 to generate a VR/AR output 308. The VR/AR output 308 can include an assistant rendering asset being rendered in a virtual-reality experience and/or in an augmented-reality experience. The assistant rendering asset can be utilized to visually and/or audibly provide the prediction data to a user. The process can then restart as additional input data is obtained.

If the confidence score is below a threshold, the user may be redirected to a live agent 310. The redirecting can include redirecting to a communication interface for communicating directly with a real world agent.

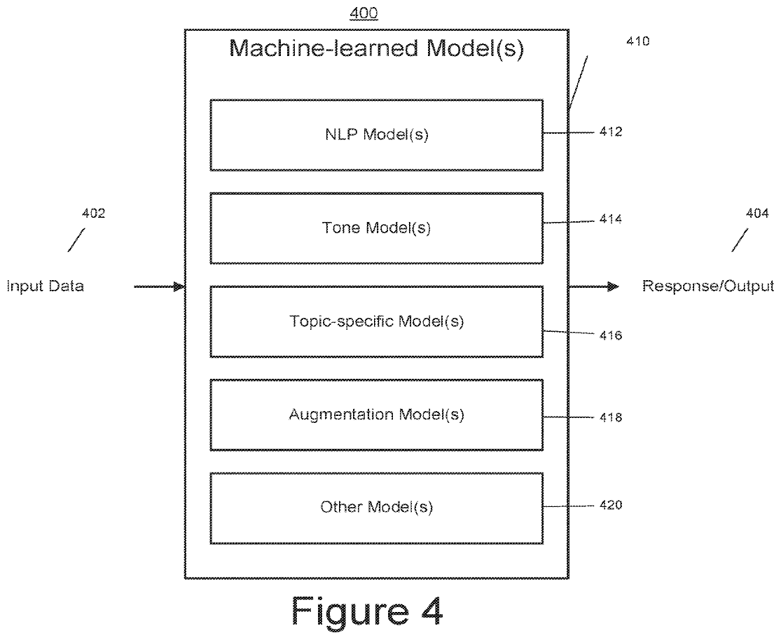

FIG. 4 depicts a block diagram of an example machine-learned model 400 according to example embodiments of the present disclosure. In particular, FIG. 4 depicts one or more machine-learned models 410 processing input data 402 to generate a response output 404. The one or more machine-learned models 410 can include one or more natural language processing models 412, one or more tone models 414, one or more topic-specific models 416, one or more augmentation models 418, and/or one or more other models 420.

The one or more natural language processing models 412 can be trained to process natural language data to generate a semantic output, a response output, a classification output, and/or a classification output. The one or more tone models 414 can be trained to process the input data 402 and determine a tone of the input data 402. The tone can be determined based on sound wave data, pitch data, diction, syntax, location, historical data, and/or one or more other contexts.

The one or more topic-specific models 416 can be trained on a topic-specific dataset associated with a particular topic (e.g., a particular service type). For example, the one or more topic-specific models 416 can be trained to generate a specialized response associated with the specific topic in response to one or more inputs. The generated response can include an answer to an input question, can include a search query for querying a topic-specific database, and/or a category classification to direct a user to a certain landing page to learn more about the specific category.

The one or more augmentation models 418 can be trained to augment an assistant rendering asset (e.g., an avatar) to replicate and/or determine the movements (and/or audible sounds) of a human when reciting a given response. In some implementations, the one or more augmentation models 418 may be trained on example data from a particular human and/or a plurality of humans.

Additionally and/or alternatively, the one or more machine-learned models 410 can include one or more other models 420 for generating an immersive virtual-reality assistant chat bot.

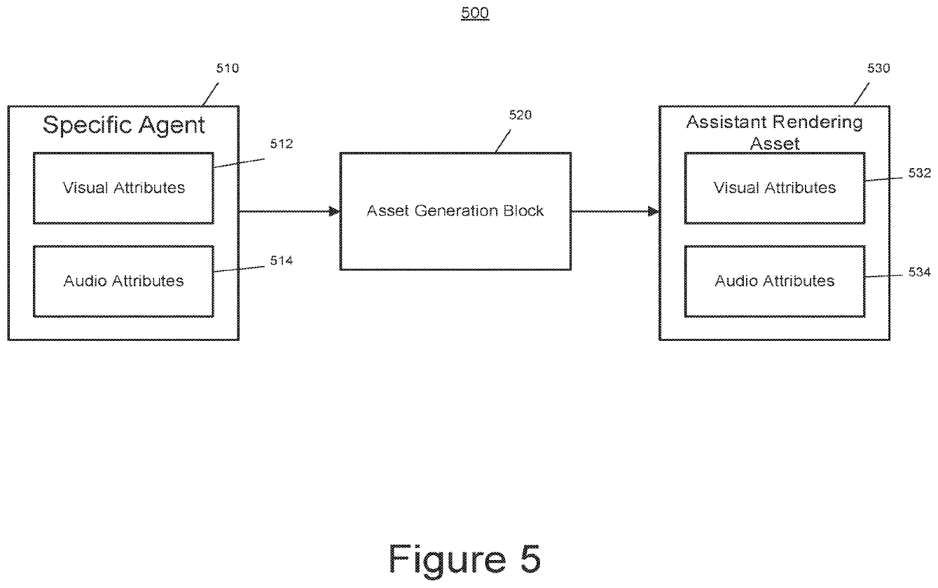

FIG. 5 depicts a block diagram of an example assistant rendering asset generation 500 according to example embodiments of the present disclosure. In particular, FIG. 5 depicts a specific agent dataset 510 processed with an asset generation block 520 to generate an assistant rendering asset 530. The specific agent dataset 510 can include visual attributes data 512 descriptive of one or more visual attributes of a specific agent (e.g., facial features, hair style, and/or body type) and/or audio attributes data 514 descriptive of one or more audio attributes of a specific agent (e.g., pitch, accent, and/or cadence).

The asset generation block 520 can process the visual attributes data 512 and the audio attributes data 514 to generate an assistant rendering asset 530. The assistant rendering asset 530 can visual attributes 532 and audio attributes 534 similar to the specific agent associated with the specific agent dataset 510.

Alternatively and/or additionally, the assistant rendering asset 530 can include attributes from a plurality of different datasets associated with a plurality of different individuals and/or a plurality of randomized attributes.

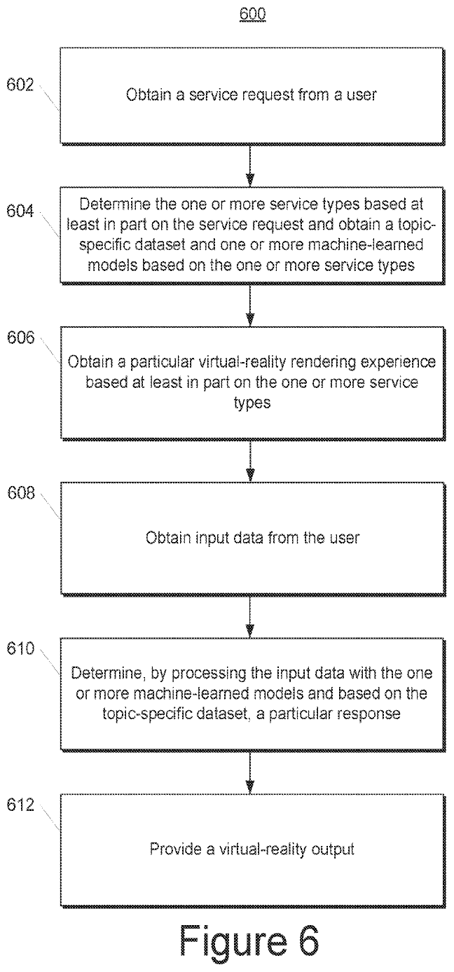

FIG. 6 depicts a flow chart diagram of an example method to perform according to example embodiments of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 602, a computing system can obtain a service request from a user. The service request can be associated with one or more service types (e.g., technical support, sales, accounting, payment services, etc.). In some implementations, each service type can be associated with a specific topic. The service request may be generated and/or obtained based on one or more interactions. The one or more interactions can include one or more interactions in a virtual environment (e.g., a virtual-reality environment, such as a virtual-reality store in which the interactions may be with a virtual reality store clerk). The service request may include a set of input data descriptive of one or more questions directed to a virtual entity (e.g., a virtual assistant rendering (e.g., a virtual avatar of an artificial intelligence chat bot)).

At 604, the computing system can determine the one or more service types based at least in part on the service request and obtain a topic-specific dataset and one or more machine-learned models based on the one or more service types. The one or more service types can be associated with a customer service topic that includes specialized information. The one or more service types can be determined based on metadata associated with the service request, one or more keywords associated with the service request, the input data of the service request (e.g., one or more lines of dialogue spoken and/or input via text input), a location in a physical world, a location in a virtual environment, a currently visited web page, and/or one or more other contextual datasets.

The topic-specific dataset can be associated with a particular topic that is associated with the one or more service types. In some implementations, the one or more machine-learned models can include a natural language processing model. The natural language processing model may have been trained to determine a semantic intent of natural language data and generate a natural language output responsive to the natural language data. Additionally and/or alternatively, the one or more machine-learned models can include an augmentation model. The augmentation model may have been trained to determine assistant rendering asset movement based on an input text string. In some implementations, the one or more machine-learned models can include a tone model. The tone model may have been trained to determine a particular tone associated with the input data. The particular tone can be utilized to determine the particular response. In some implementations, the one or more machine-learned models may have been trained on the topic-specific dataset. The topic-specific dataset can include a plurality of input examples and a plurality of output examples associated with the one or more service types.

At 606, the computing system can obtain a particular virtual-reality rendering experience (and/or an augmented-reality rendering experience) based at least in part on the one or more service types. The particular virtual-reality (and/or the augmented-reality) rendering experience can be obtained from a virtual-reality/augmented-reality database including a plurality of virtual-reality rendering experiences and/or augmented-reality rendering experiences. In some implementations, the particular virtual-reality (and/or the augmented-reality) rendering experience can include an assistant rendering asset associated with the one or more service types.

At 608, the computing system can obtain input data from the user. The input data can include dialogue data descriptive of one or more lines of dialogue. The input data can be provided as part of the service request and/or may be obtained following the processing of the service request. The input data can include audio data, text data, image data, video data, and/or latent encoding data. The input data may be processed to generate natural language data that can then be processed by the one or more machine-learned models.

At 610, the computing system can determine, by processing the input data with the one or more machine-learned models and based on the topic-specific dataset, a particular response. The particular response can be responsive to the one or more lines of dialogue. The determination can include determining a tone associated with the input data, determining a semantic intent of the input data (e.g., a question associated with the input data), determining prediction data (e.g., a prediction of an answer to a determined question and/or response associated with the input data), and generating the particular response that is descriptive of the prediction data and is conditioned based on the determined tone. For example, a neural tone may be utilized for wording the response when a negative tone is determined (e.g., when profanity is utilized). Alternatively and/or additionally, an upbeat tone may be utilized when an upbeat tone is determined.

At 612, the computing system can provide a virtual-reality output (and/or an augmented-reality output). The virtual-reality (and/or the augmented-reality) output can include a rendering of the assistant rendering asset simulating vocally-communicating the particular response. In some implementations, the virtual-reality (and/or the augmented-reality) output can include one or more three-dimensional renderings, one or more images, and/or one or more additional resources. The virtual-reality (and/or the augmented-reality) output may include a virtual-reality experience (and/or an augmented-reality experience) associated with the particular response that may include one or more additional indicators.

In some implementations, the computing system can obtain additional input data. The additional input data can be descriptive of one or more additional inputs. The computing system can determine the additional input data is associated with a redirect request. The redirect request can be descriptive of a transition to a communication portal. The computing system can generate a service communication portal in a user interface. In some implementations, the service communication portal can be associated with a specific agent associated with the one or more service types. The assistant rendering asset can be configured to appear similar to the specific agent.

In some implementations, determining the additional input data is associated with the redirect request can include processing the additional input data with the one or more machine-learned models to generate predicted additional response data. The predicted additional response data can include a predicted additional response and a confidence score. In some implementations, the confidence score can be descriptive of a predicted likelihood that the predicted additional response is responsive to the additional input data. Determining the additional input data is associated with the redirect request can include determining the confidence score is below a threshold value.

Alternatively and/or additionally, determining the additional input data is associated with the redirect request can include determining the additional input data is descriptive of a selection of a redirect interface element.

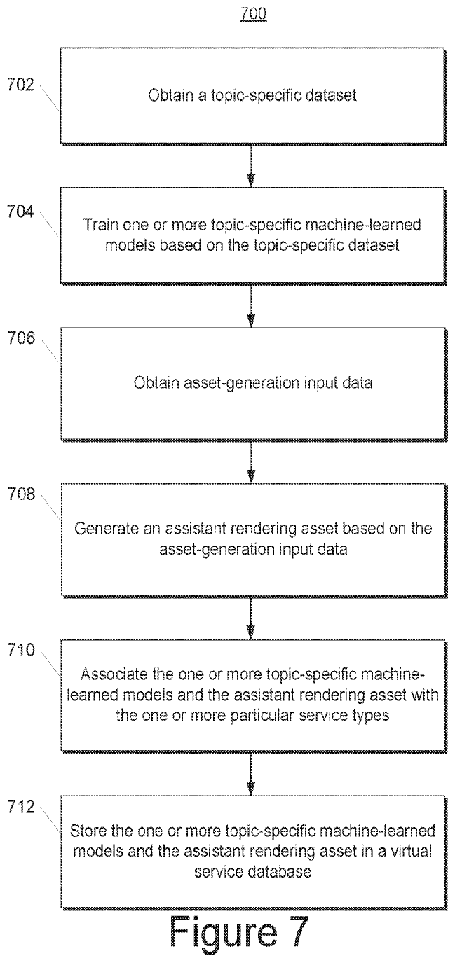

FIG. 7 depicts a flow chart diagram of an example method to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can obtain a topic-specific dataset. The topic-specific dataset can include a plurality of input examples and a plurality of output examples associated with one or more particular service types. In some implementations, the plurality of input examples can be associated with a plurality of frequently asked questions. Additionally and/or alternatively, the plurality of output examples can be associated with a plurality of respective answers to the plurality of frequently asked questions.

At 704, the computing system can train one or more topic-specific machine-learned models based on the topic-specific dataset. The one or more topic-specific machine-learned models can include one or more natural language processing models. The one or more topic-specific machine-learned models may be trained to understand topic-specific vocabulary and/or terminology. Additionally and/or alternatively, the one or more topic-specific machine-learned models may be trained to diagnose and/or determine one or more issues based on received input data.

At 706, the computing system can obtain asset-generation input data. The asset-generation input data can be associated with one or more attributes of a specific agent. In some implementations, the one or more attributes can include one or more visual attributes associated with the specific agent. The one or more attributes can include one or more audio attributes associated with the specific agent.

At 708, the computing system can generate an assistant rendering asset based on the asset-generation input data. The assistant rendering asset can be descriptive of a three-dimensional avatar that may resemble the specific agent. The assistant rendering asset may be generated to include similar facial features, similar facial movements, similar body movements, and/or a similar voice.

At 710, the computing system can associate the one or more topic-specific machine-learned models and the assistant rendering asset with the one or more particular service types. The association can include generating a data packet that may be stored with a service type specific label.

At 712, the computing system can store the one or more topic-specific machine-learned models and the assistant rendering asset in a virtual service database. The virtual service database can include a plurality of searchable datasets. In some implementations, the one or more topic-specific machine-learned models and the assistant rendering asset can be stored in the virtual service database with a service label associated with the one or more particular service types.

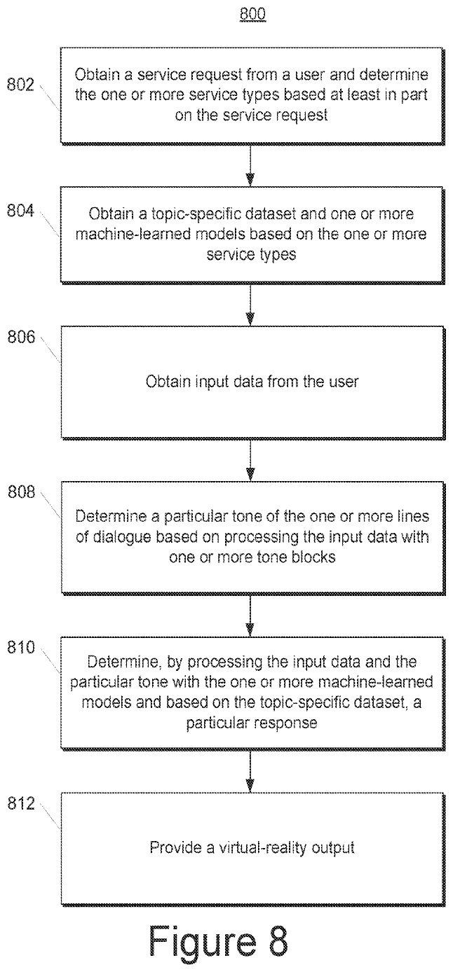

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can obtain a service request from a user and determine the one or more service types based at least in part on the service request. The service request can be associated with one or more service types. In some implementations, each service type can be associated with a specific topic.

At 804, the computing system can obtain a topic-specific dataset and one or more machine-learned models based on the one or more service types. The determination may be based on one or more interactions with a user interface. The topic-specific dataset can be associated with a particular topic that is associated with the one or more service types.

At 806, the computing system can obtain input data from the user. The input data can include dialogue data descriptive of one or more lines of dialogue. In some implementations, the one or more lines of dialogue can include one or more questions associated with a particular service request.

At 808, the computing system can determine a particular tone of the one or more lines of dialogue based on processing the input data with one or more tone blocks. The particular tone may be determined based on processing with one or more machine-learned models of the one or more tone blocks. In some implementations, the one or more machine-learned models can include one or more language models trained to parse text and determine a tone of input data based on the segments individually and/or as a whole. In some implementations, the particular tone may be determined based on the vocabulary used, the syntax used, past interaction data, structure, setting tone of a voice, use of capitalization in text, and/or one or more other contextual features. The particular tone may be determined based in part on the one or more service types. For example, an input associated with a sales chat bot and help desk chat bot may be associated with different indicators and/or thresholds for different tones.

At 810, the computing system can determine, by processing the input data and the particular tone with the one or more machine-learned models and based on the topic-specific dataset, a particular response. The particular response can be responsive to the one or more lines of dialogue. In some implementations, the particular response can differ based on the particular tone.

At 812, the computing system can provide a virtual-reality output. The virtual-reality output can include a rendering of an assistant rendering asset simulating vocally-communicating the particular response. The virtual-reality output can include a visual output (e.g., a three-dimensional avatar displaying one or more movements) and an audio output (e.g., speech data that recites one or more words associated with the particular response).

In some implementations, providing the virtual-reality output can include obtaining a particular virtual-reality rendering experience based at least in part on the one or more service types. The particular virtual-reality rendering experience can be obtained from a virtual-reality database including a plurality of virtual-reality rendering experiences. The particular virtual-reality rendering experience can include the assistant rendering asset. In some implementations, the assistant rendering asset can be associated with the one or more service types.

Although FIG. 8 is depicted as generating and providing a virtual-reality output, the computing system can be utilized to generate mixed-reality outputs, augmented-reality outputs, and/or another user interface output. For example, the assistant rendering asset can be associated with a mixed-reality experience and/or an augmented-reality experience. The augmented-reality output may be utilized to provide a rendering of an individual conveying the particular response in a user's environment.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computing system, the system comprising:
one or more processors; and
one or more non-transitory computer-readable media that collectively store instructions that, when executed by the one or more processors, cause the computing system to perform operations, the operations comprising:
obtaining a service request from a user, wherein the service request is associated with one or more service types, wherein each service type is associated with a specific topic;
determining the one or more service types based at least in part on the service request;
obtaining a topic-specific dataset and one or more machine-learned models based on the one or more service types, wherein the topic-specific dataset is associated with a particular topic that is associated with the one or more service types;
obtaining a particular virtual-reality rendering experience based at least in part on the one or more service types, wherein the particular virtual-reality rendering experience is obtained from a virtual-reality database comprising a plurality of virtual-reality rendering experiences, wherein the particular virtual-reality rendering experience comprises an assistant rendering asset associated with the one or more service types;
obtaining input data from the user, wherein the input data comprises dialogue data descriptive of one or more lines of dialogue;
determining, by processing the input data with the one or more machine-learned models and based on the topic-specific dataset, a particular response, wherein the particular response is responsive to the one or more lines of dialogue; and
providing a virtual-reality output, wherein the virtual-reality output comprises a rendering of the assistant rendering asset simulating vocally-communicating the particular response.

2. The system of claim 1, wherein the one or more service types are associated with a customer service topic that comprises specialized information.

3. The system of claim 1, wherein the operations further comprise:
obtaining additional input data, wherein the additional input data is descriptive of one or more additional inputs;
determining the additional input data is associated with a redirect request, wherein the redirect request is descriptive of a transition to a communication portal; and
generating a service communication portal in a user interface, wherein the service communication portal is associated with a specific agent associated with the one or more service types.

4. The system of claim 3, wherein the assistant rendering asset is configured to appear similar to the specific agent.

5. The system of claim 3, wherein determining the additional input data is associated with the redirect request comprises:
processing the additional input data with the one or more machine-learned models to generate predicted additional response data, wherein the predicted additional response data comprises a predicted additional response and a confidence score, wherein the confidence score is descriptive of a predicted likelihood that the predicted additional response is responsive to the additional input data; and
determining the confidence score is below a threshold value.

6. The system of claim 3, wherein determining the additional input data is associated with the redirect request comprises:
determining the additional input data is descriptive of a selection of a redirect interface element.

7. The system of claim 1, wherein the one or more machine-learned models comprise a natural language processing model, wherein the natural language processing model was trained to determine a semantic intent of natural language data and generate a natural language output responsive to the natural language data.

8. The system of claim 1, wherein the one or more machine-learned models comprise an augmentation model, wherein the augmentation model was trained to determine assistant rendering asset movement based on an input text string.

9. The system of claim 1, wherein the one or more machine-learned models comprise a tone model, wherein the tone model was trained to determine a particular tone associated with the input data, and wherein the particular tone is utilized to determine the particular response.

10. The system of claim 1, wherein the one or more machine-learned models were trained on the topic-specific dataset.

11. The system of claim 1, wherein the topic-specific dataset comprises a plurality of input examples and a plurality of output examples associated with the one or more service types.

12. A computer-implemented method, the method comprising:
obtaining, by a computing system comprising one or more processors, a topic-specific dataset, wherein the topic-specific dataset comprises a plurality of input examples and a plurality of output examples associated with one or more particular service types;
training, by the computing system, one or more topic-specific machine-learned models based on the topic-specific dataset, wherein the one or more topic-specific machine-learned models comprise one or more natural language processing models;
obtaining, by the computing system, asset-generation input data, wherein the asset-generation input data is associated with one or more attributes of a specific agent;
generating, by the computing system, an assistant rendering asset based on the asset-generation input data;
associating, by the computing system, the one or more topic-specific machine-learned models and the assistant rendering asset with the one or more particular service types; and
storing, by the computing system, the one or more topic-specific machine-learned models and the assistant rendering asset in a virtual service database, wherein the virtual service database comprises a plurality of searchable datasets.

13. The method of claim 12, wherein the one or more attributes comprise one or more visual attributes associated with the specific agent.

14. The method of claim 12, wherein the one or more attributes comprise one or more audio attributes associated with the specific agent.

15. The method of claim 12, wherein the plurality of input examples are associated with a plurality of frequently asked questions, and wherein the plurality of output examples are associated with a plurality of respective answers to the plurality of frequently asked questions.

16. The method of claim 12, wherein the one or more topic-specific machine-learned models and the assistant rendering asset are stored in the virtual service database with a service label associated with the one or more particular service types.

17. One or more non-transitory computer-readable media that collectively store instructions that, when executed by one or more computing devices, cause the one or more computing devices to perform operations, the operations comprising:
obtaining a service request from a user, wherein the service request is associated with one or more service types, wherein each service type is associated with a specific topic;
determining the one or more service types based at least in part on the service request;
obtaining a topic-specific dataset and one or more machine-learned models based on the one or more service types, wherein the topic-specific dataset is associated with a particular topic that is associated with the one or more service types;
obtaining input data from the user, wherein the input data comprises dialogue data descriptive of one or more lines of dialogue;
determining a particular tone of the one or more lines of dialogue based on processing the input data with one or more tone blocks;
determining, by processing the input data and the particular tone with the one or more machine-learned models and based on the topic-specific dataset, a particular response, wherein the particular response is responsive to the one or more lines of dialogue; and
providing a virtual-reality output, wherein the virtual-reality output comprises a rendering of an assistant rendering asset simulating vocally-communicating the particular response.

18. The one or more non-transitory computer-readable media of claim 17, wherein providing the virtual-reality output comprises:
obtaining a particular virtual-reality rendering experience based at least in part on the one or more service types, wherein the particular virtual-reality rendering experience is obtained from a virtual-reality database comprising a plurality of virtual-reality rendering experiences, wherein the particular virtual-reality rendering experience comprises the assistant rendering asset, wherein the assistant rendering asset is associated with the one or more service types.

19. The one or more non-transitory computer-readable media of claim 17, wherein the particular response differs based on the particular tone.

20. The one or more non-transitory computer-readable media of claim 17, wherein the one or more lines of dialogue comprise one or more questions associated with a particular service request.
